(19) United States
(12) Patent Application Publication
(10) Pub. No.: US 2011/0014381 A1
(43) Pub. Date: Jan. 20, 2011

(54) METHOD FOR MAKING A LITHOGRAPHIC PRINTING PLATE SUPPORT

(75) Inventors: Paola Campestrini, Antwerpen (BE); Dirk Faes, Herselt (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/920,872

(22) PCT Filed: Feb. 25, 2009
(86) PCT No.: PCT/EP09/01327

§ 371 Date: Sep. 3, 2010

Related U.S. Application Data
(60) Provisional application No. 61/033,436, filed on Mar. 4, 2008.

(30) Foreign Application Priority Data
Mar. 4, 2008 (EP) 08102242.8

(51) Int. Cl. C25F 3/20; B05D 3/02

(52) U.S. Cl. 427/372.2; 205/640

(57) ABSTRACT

A method for making a lithographic printing plate support includes the steps of providing an aluminum support; graining the support in a graining electrolyte solution; and treating the grained support in a desmut electrolyte solution containing hydrochloric acid by applying a direct current resulting in a charge density Q; wherein the desmut electrolyte solution has a pH less than 1 and Q is at least 400 C/dm².

### CROSS-REFERENCE TO RELATED APPLICATIONS

This application is a 371 National Stage Application of PCT/EP2009/001327, filed Feb. 25, 2009. This application claims the benefit of U.S. Provisional Application No. 61/033,436, filed Mar. 4, 2008, which is incorporated by reference herein in its entirety. In addition, this application claims the benefit of European Application No. 08102242.8, filed Mar. 4, 2008, which is also incorporated by reference herein in its entirety.

### BACKGROUND OF THE INVENTION

1. Field of the Invention

The present invention relates to a method for making a lithographic printing plate support.

2. Description of the Related Art

Lithographic printing presses use a so-called printing master such as a printing plate which is mounted on a cylinder of the printing press. The master carries a lithographic image on its surface and a print is obtained by applying ink to the image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. In addition to the well-known photosensitive, so-called pre-sensitized plates, which are suitable for UV contact exposure through a film mask, also heat-sensitive printing plate precursors have become very popular in the late 1990s. Such thermal materials offer the advantage of daylight stability and are especially used in the so-called computer-to-plate method wherein the plate precursor is directly exposed, i.e. without the use of a film mask. The material is exposed to heat or to infrared light and the generated heat triggers a (physico-) chemical process, such as ablation, polymerization, insolubilization by cross linking of a polymer, heat-induced solubilization, or by particle coagulation of a thermoplastic polymer latex.

Thermal processes which enable plate making without wet processing are for example based on ablation of one or more layers of the coating. At the exposed areas the surface of an underlying layer is revealed which has a different affinity towards ink or fountain solution than the surface of the unexposed coating; the image (printing) and non-image or background (non-printing) areas are obtained.

Another type of printing plates based on thermal processes requiring no wet processing step are for example plates based on switching—i.e. plates of which the surface is irreversibly changed from a hydrophilic surface to a hydrophobic surface or vice versa upon exposure to heat and/or light. These so-called “switchable polymer systems” are based on different working mechanism such as for example masking/demasking of a polar group or destruction/generation of charge.

The most popular thermal plates form an image by a heat-induced solubility difference in an alkaline developer between exposed and non-exposed areas of the coating. The coating typically includes an oleophilic binder, e.g. a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in e.g. EP-A 625728, 823327, 825927, 864420, 894622 and 901902. Negative working preferred embodiments of such thermal materials often require a pre-heat step between exposure and development as described in e.g. EP-A 625,728.

Negative working plate precursors which do not require a pre-heat step may contain an image-recording layer that works by heat-induced particle coalescence of a thermoplastic polymer latex, as described in e.g. EP-As 770 494, 770 495, 770 496 and 770 497. These patents disclose a method for making a lithographic printing plate including the steps of (1) image-wise exposing an imaging element including hydrophobic thermoplastic polymer particles dispersed in a hydrophilic binder and a compound capable of converting light into heat, (2) and developing the image-wise exposed element by applying fountain and/or ink.

U.S. Pat. No. 4,482,434 discloses the roughening of aluminum by applying an electrolyte solution under the action of an alternating current having a frequency in the range from 0.3 to 15 Hz.

EP 422 682 discloses a method for producing an aluminum printing plate support including an electrochemical surface-roughening step in an acidic aqueous solution, and a cathodic electrolysis in an aqueous neutral electrolyte solution to remove smut.

U.S. Pat. No. 7,087,361 and U.S. Pat. No. 7,078,155 disclose a cathodic electrolytic treatment—which is performed on an aluminum plate between a first and a second electrolytic graining treatment—in an electrolyte solution containing nitric acid or hydrochloric acid and whereby an amount of electricity ranging between 3 C/dm² and 80 C/dm² is applied.

U.S. Pat. No. 4,482,444 discloses a process for making aluminum support materials for printing plates including the steps of electrochemically roughening the support followed by a cathodic treatment carried out in an aqueous electrolyte which has a pH value ranging from 3 to 11 and includes a water-soluble salt; optionally followed by an anodic oxidation and a hydrophilizing post-treatment step.

U.S. Pat. No. 3,935,080 discloses a method for producing an aluminum substrate including three steps in sequence including electrolytically graining the surface of the aluminum sheet, thereafter cathodically cleaning the grained sheet by exposing it to a concentrated solution of sulfuric acid; and finally anodizing the cathodically cleaned sheet by exposing it to a second concentrated solution of sulfuric acid and imposing a direct current.

U.S. Pat. No. 4,786,381 discloses a process for electrochemically modifying aluminum supports which have been grained in a multi-stage process. A direct current is applied in an electrolyte solution containing at least one water-soluble salt in a concentration from about 3 g/l up to the saturation limit and/or an acid in a concentration in the order of about 0.5 to 50 g/l having a pH from 0 to 11 for about 5 to 90 seconds.

In general, the use of aluminum substrates as supports for lithographic printing plates requires that they undergo several treatments such as for example graining and anodizing. Lithographic supports are roughened or grained to improve the adhesion of an imaging layer to the support and anodizing may be carried out to improve the abrasion resistance and water retention or wetting characteristics of the non-image areas of the support. The aluminum support is typically roughened or grained by an electrochemical roughening step: electrolyzing the surface of the aluminum support in an electrolyte solution using the support as an electrode and for example graphite as counter electrode. By varying the type and/or concentration of the electrolyte solution and the applied voltage in the electrochemical roughening step, different types of grain can be obtained. Usually an alternating current such as a sine wave current, a trapezoidal wave current, or a rectangular wave current is applied while the aluminum support is immersed in an acidic electrolyte solution. Thus, the support is alternately subjected to a positive and a negative voltage. When the positive voltage is applied, a cathodic reaction occurs on the surface of the aluminum wherein a so-called smut layer (Al(OH)₃ layer) is build up; when the negative voltage is applied, an anodic reaction occurs wherein pits are formed. Before the anodizing step, usually a desmut step is carried out to remove the smut layer formed during the cathodically polarised cycle of the graining step. In order to obtain a support with an even and uniform surface without the occurrence of streaks and so-called mottle or cloudiness—also referred to in the art as a surface having good cosmetics—, the smut layer should be removed as good as possible. In addition, the partial or complete removal of the smut layer is essential for obtaining a substrate with a good surface morphology. The morphology of the surface highly influences the lithographic behaviour of the related printing plate: indeed, a support having a surface with small pits, even in size and uniformly distributed over the surface is essential for obtaining high quality printing plates showing both good adhesion properties of the coating layer as well as a good water retention in the non-image areas.

The desmutting step is typically a chemical process carried out in an aqueous alkaline or acidic solution. However, such a chemical process is time consuming and in the industrial production of printing plate supports, it is an ongoing requirement to produce printing plate supports in shorter time periods.

### SUMMARY OF THE INVENTION

A preferred embodiment of the present invention provides an alternative method for making a lithographic aluminum printing plate support having excellent cosmetics—i.e. a smooth, even and uniform surface without the occurrence of streaks and/or mottle or cloudiness.

According to a preferred embodiment, a method for making a lithographic printing plate support includes the steps of:
providing an aluminum support;
graining the support in a graining electrolyte solution;
treating the grained support in a desmut electrolyte solution containing hydrochloric acid by applying a direct current resulting in a charge density Q;
   characterized in that the aqueous electrolyte solution has a pH<1 and that Q is at least 400 C/dm².

It was surprisingly found that treating a grained aluminum support in an aqueous electrolyte solution having a pH<1 and containing hydrochloric acid with a direct current resulting in a charge density of at least 400 C/dm², highly improves the cosmetics of the support—i.e. the appearance of the surface of the support. The surface is even and smooth and does not show any mottle and/or streaks. Moreover, the smut layer, which is build up in the graining step, is efficiently removed at very short reaction times which may not only significantly shorten the time of the production process of aluminum supports but also may result in supports with improved lithographic properties. Preferably, the supports show a uniform roughening structure without the occurrence of major cavities resulting in an improved control during exposure and an improved resolution of the heat- and/or light-sensitive coating of the printing plate. The less deep surface roughness may further lead to a reduced dampening solution consumption during printing and to an increased abrasion resistance of the surface of the substrate. Furthermore, the supports obtained according to preferred methods of the current invention may be brighter which results in an improved contrast between the image and the non-image parts of the printing plate after exposure and development.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 and FIG. 2 each show schematically a preferred embodiment of the method of the present invention.

### DETAILED DESCRIPTION OF THE PREFERRED EMBODIMENTS

The lithographic printing plate support according to a preferred method of the present invention is an aluminum support. The support may be a sheet-like material such as a plate or it may be a cylindrical element such as a sleeve which can be slid around a print cylinder of a printing press.

The surface of the aluminum support is grained aluminum. By graining (or roughening) the aluminum support, both the adhesion of the printing image and the wetting characteristics of the non-image areas are improved. The surface of the support is grained using an acid containing graining electrolyte solution, hereinafter referred to as the graining electrolyte solution. Preferably the graining electrolyte solution includes at least one of the following chemicals: HNO₃, HCl and/or H₃PO₄. The concentration of HCl, HNO₃ and/or H₃PO₄ in the graining electrolyte solution preferably varies between 1 g/l and 50 g/l; more preferably between 5 g/l and 30 g/l; most preferably between 7 g/l and 25 g/l. In a highly preferred embodiment the graining electrolyte solution contains hydrochloric acid.

The graining electrolyte solution may further contain anions such as sulphate, phosphate, acetate or nitrate anions at a concentration varying between 1 g/l and 50 g/l; more preferably between 5 g/l and 30 g/l; most preferably between 6 g/l and 20 g/l.

The graining may be carried out using alternating current at a voltage ranging for example from 5V to 50V, preferably from 20V to 40V for a period ranging from 5 to 120 seconds. Generally, the current density ranges from 10 A/dm² to 250 A/dm², preferably from 50 A/dm² to 200 A/dm², and most preferably from 60 A/dm² to 150 A/dm². The charge density preferably ranges from 300 C/dm² to 1500 C/dm², more preferably from 400 C/dm² to 1200 C/dm², and most preferably from 500 C/dm² to 1050 C/dm². The electrolyte temperature may be at any suitable temperature but preferably ranges from 20° C. to 55° C., more preferably from 30° C. to 45° C.

Optionally, the graining electrolyte solution may contain additives such as for example benzoic acid derivatives and/or sulphonic acid derivatives. Preferably the concentration of the benzoic acid derivative or the sulphonic acid derivative varies between 0.0001 mol/l and 0.2 mol/l, more preferably between 0.0001 mol/l and 0.1 mol/l, most preferably between 0.001 mol/l and 0.05 mol/1.

A preferred benzoic acid derivative includes a benzoic acid such as ortho-, meta- or para-substituted benzoic acid or di- or tri-substituted benzoic acid, a phtalic acid, isophtalic acid, terephtalic acid, salicylic acid, benzoic anhydride, 1-naphtoic acid or 2-naphtoic acid; or salts or esters thereof and each of which may be substituted. Suitable salts are for example sodium, potassium or ammonium salts. A suitable ester is for example an optionally substituted alkyl benzoic acid wherein the alkyl group represents a straight, branched or cyclic alkyl group having up to 10 carbon atoms.

The substituents optionally present on the benzoic acid derivatives are selected from a halogen, a nitro group, a straight, branched or cyclic alkyl group having up to 10 carbon atoms, a hydroxyl group, an amino group, a sulphonic acid group, a methoxy group, or combinations thereof. Preferably, the benzoic acid derivative is an optionally substituted benzoic acid.

A preferred sulphonic acid derivative includes a benzenesulphonic acid, benzenedisulphonic acid, pyridine sulphonic acid, naphthalene sulphonic acid, naphthalene disulphonic acid, alkyl sulphonic acid, alkylene sulphonic acid and quinoline sulphonic acid; or salts or esters thereof; and each of which may be substituted. Suitable salts are for example sodium, potassium or ammonium salts. A suitable ester is for example an optionally substituted alkyl ester of a sulphonic acid such as an optionally substituted alkyl benzenesulphonic acid or a pyridine alkyl sulphonic acid; wherein the alkyl group represents a straight, branched or cyclic alkyl group having up to 10 carbon atoms. The sulphonic acid derivatives may be mono- (ortho, meta or para), di- or tri-substituted. The substituents optionally present on the sulphonic acid derivatives include a halogen, an amino group, a nitro group, a hydroxyl group, a methoxy group, a carboxylic acid group, an optionally substituted straight, branched or cyclic alkyl group having up to 10 carbon atoms, or combinations thereof. Preferably, the sulphonic acid derivative is an optionally substituted benzenesulphonic acid.

After the graining step, the smut layer build up during the graining step is for the most part removed by means of a desmutting step. In a preferred embodiment, the smut layer is completely removed during the desmutting step. The desmutting step is carried out in an aqueous acidic desmut solution, hereinafter referred to as the desmut electrolyte solution. The desmutting desmut step involves a cathodic polarization step. The desmut electrolyte solution includes HCl at a concentration varying between 1 g/l and 50 g/l; more preferably between 5 g/l and 30 g/l; most preferably between 7 g/l and 25 g/l. The desmut electrolyte solution has a pH<1, more preferably a pH>0 and <1, most preferably a pH>0 and <0.5. Alternatively, the pH is preferably ranging between 0.1 and 0.9, and more preferably ranging between 0.1 and 0.6. The desmut electrolyte solution may further contain anions such as sulphate, phosphate, acetate or nitrate anions at a concentration varying between 1 g/l and 50 g/l; more preferably between 5 g/l and 30 g/l; most preferably between 6 g/l and 20 g/l. The electrolyte temperature may be at any suitable temperature but preferably ranges from 20° C. to 55° C., more preferably from 30° C. to 45° C.

Optionally, the desmut electrolyte solution may contain additives such as for example benzoic acid derivatives and/or sulphonic acid derivatives. Preferably the concentration of the benzoic acid derivative or the sulphonic acid derivative varies between 0.0001 mol/l and 0.2 mol/l, more preferably between 0.0001 mol/l and 0.1 mol/l, most preferably between 0.001 mol/l and 0.05 mol/l. Preferred benzoic acid derivatives and preferred sulphonic acid derivatives are described in the above paragraphs [0024] to [0027].

The desmut step is carried out using direct current at a voltage ranging for example from 5V to 50V, preferably from 20V to 40V. The charge density is at least 400 C/dm²; preferably at least 450 C/dm² and most preferably at least 500 C/dm². Alternatively, the charge density preferably ranges between 400 C/dm² and 1000 C/dm², more preferably between 450 C/dm² and 750 C/dm² and most preferably between 500 C/dm² and 600 C/dm². The current density ranges from 50 A/dm² to 350 A/dm², preferably from 60 A/dm² to 300 A/dm², and most preferably from 80 A/dm² to 250 A/dm².

The desmut reaction time period preferably varies between 0.1 s and 10 s, more preferably between 0.2 s and 8 s and most preferably between 0.2 s and 5 s. In a preferred embodiment, the desmut step is performed in less than 5 s.

In a highly preferred embodiment, the graining electrolyte solution used in the graining step, has the same composition as the desmut electrolyte solution applied in the desmut step.

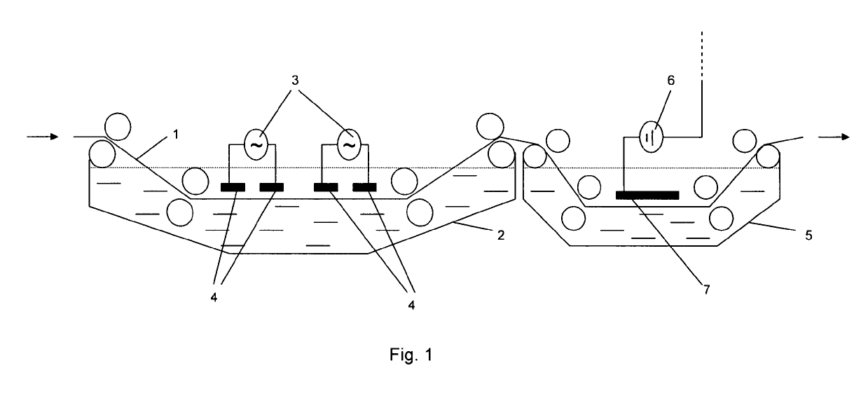

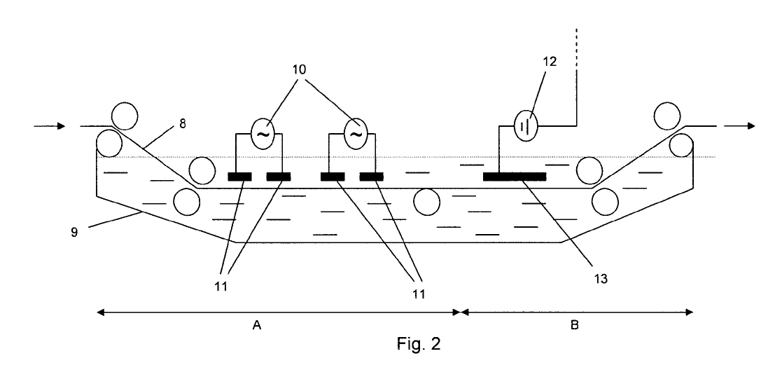

The desmut treatment is preferably performed in one or more treatment tank(s) containing the desmut electrolyte solution after the graining step which is preferably performed in one or more graining tank(s) filled with the graining electrolyte solution. The composition of the graining electrolyte solution may be the same as the composition of the desmut electrolyte solution. In a particularly preferred embodiment, the graining step and the desmut step are carried out in the same treatment tank(s). A typical example of these preferred embodiments is schematically shown in respectively FIGS. 1 and 2.

In FIG. 1, the aluminum support (1) is conveyed through the graining tank (2) containing the graining electrolyte solution. Graining tank (2) is provided with AC power sources (3) which provide an alternating current to the graining electrodes (4). Subsequently, the aluminum support is conveyed through the treatment tank (5) containing the desmut electrolyte solution. The treatment tank (5) is provided with one or more DC power sources (6) which provide a direct current to the desmutting cathode (7).

In FIG. 2, the aluminum support (8) is conveyed through the treatment tank (9) containing the desmut electrolyte solution. The treatment tank (9) has two zones (A) and (B). Zone (A) is provided with one or more AC power sources (10) which provide an alternating current to the graining electrodes (11) were the graining process is performed. Zone B is provided with one or more DC power sources (12) which provide a direct current to the desmutting cathode (13) were the desmut step is performed.

It was surprisingly found that by applying DC current to the support immediately after the graining step and in the same electrolyte solution, the desmut step can be eliminated as a physically separate step.

The aluminum is further preferably anodized by means of anodizing techniques employing sulphuric acid and/or a sulphuric acid/phosphoric acid mixture whereby an aluminum oxide layer (Al₂O₃) is formed. By anodising the aluminum support, its abrasion resistance and hydrophilic nature are improved. The microstructure as well as the thickness of the Al₂O₃ layer are determined by the anodising step, the anodic weight (g/m² Al₂O₃ formed on the aluminum surface) varies between 1 and 8 g/m². Methods of anodizing are known in the art and are for example disclosed in GB 2,088,901.

The aluminum substrate according to a preferred embodiment of the present invention may be post-treated to further improve the hydrophilic properties of its surface. For example, the aluminum oxide surface may be silicated by treatment with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with an organic acid and/or salt thereof, e.g. carboxylic acids, hydrocarboxylic acids, sulphonic acids or phosphoric acids, or their salts, e.g. succinates, phosphates, phosphonates, sulphates, and sulphonates. A citric acid or citrate solution is preferred. This treatment may be carried out at room temperature or may be carried out at a slightly elevated temperature of about 30° C. to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulfuric acid esters of polyvinyl alcohol, and acetals of polyvinyl alcohols formed by reaction with a sulfonated aliphatic aldehyde. It is further evident that one or more of these post treatments may be carried out alone or in combination. More detailed descriptions of these treatments are given in GB 1084070, DE 4423140, DE 4417907, EP 659909, EP 537633, DE 4001466, EP A 292801, EP A 291760 and U.S. Pat. No. 4,458,005.

According to a preferred embodiment of the present invention, there is also provided a method for making a lithographic printing plate precursor including the steps of providing a support as discussed in detail above, applying a coating solution including at least one heat- or light-sensitive imaging layer onto the support and than drying the obtained precursor.

The precursor can be negative or positive working, i.e. can form ink-accepting areas at exposed or at non-exposed areas respectively. Below, suitable examples of heat- and light-sensitive coatings are discussed in detail.

### Heat-Sensitive Printing Plate Precursors.

The imaging mechanism of thermal printing plate precursors can be triggered by direct exposure to heat, e.g. by means of a thermal head, or by the light absorption of one or more compounds in the coating that are capable of converting light, more preferably infrared light, into heat.

A first suitable example of a thermal printing plate precursor is a precursor based on heat-induced coalescence of hydrophobic thermoplastic polymer particles which are preferably dispersed in a hydrophilic binder, as described in e.g. EP 770 494; EP 770 495; EP 770 497; EP 773 112; EP 774 364; EP 849 090, EP 1 614 538; EP 1 614 539; EP 1 614 540; WO 2006/133741; WO 2007/045515; EP 1 777 067; EP 1 767 349 and WO 2006/037716.

In a second suitable preferred embodiment, the thermal printing plate precursor includes a coating including an aryldiazosulfonate homo- or copolymer which is hydrophilic and soluble in the processing liquid before exposure to heat or UV light and rendered hydrophobic and less soluble after such exposure.

Preferred examples of such aryldiazosulfonate polymers are the compounds which can be prepared by homo- or copolymerization of aryldiazosulfonate monomers with other aryldiazosulfonate monomers and/or with vinyl monomers such as (meth)acrylic acid or esters thereof, (meth)acrylamide, acrylonitrile, vinylacetate, vinylchloride, vinylidene chloride, styrene, α-methyl styrene etc. Suitable aryldiazosulfonate monomers are disclosed in EP-A 339393, EP-A 507008 and EP-A 771645 and suitable aryldiazosulfonate polymers are disclosed in EP 507,008, EP 960,729, EP 960,730 and EP1,267,211.

A further suitable thermal printing plate is positive working and relies on heat-induced solubilization of an oleophilic resin. The oleophilic resin is preferably a polymer that is soluble in an aqueous developer, more preferably an aqueous alkaline developing solution with a pH between 7.5 and 14. Preferred polymers are phenolic resins e.g. novolac, resoles, polyvinyl phenols and carboxy substituted polymers. Typical examples of these polymers are described in DE-A-4007428, DE-A-4027301 and DE-A-4445820. The amount of phenolic resin present in the first layer is preferably at least 50% by weight, preferably at least 80% by weight relative to the total weight of all the components present in the first layer.

In a preferred embodiment, the oleophilic resin is preferably a phenolic resin wherein the phenyl group or the hydroxy group is chemically modified with an organic substituent. The phenolic resins which are chemically modified with an organic substituent may exhibit an increased chemical resistance against printing chemicals such as fountain solutions or press chemicals such as plate cleaners. Examples of such chemically modified phenolic resins are described in EP-A 0 934 822, EP-A 1 072 432, U.S. Pat. No. 5,641,608, EP-A 0 982 123, WO 99/01795, EP-A 02 102 446, EP-A 02 102 444, EP-A 02 102 445, EP-A 02 102 443, EP-A 03 102 522. The modified resins described in EP-A 02 102 446, are preferred, especially those resins wherein the phenyl-group of the phenolic resin is substituted with a group having the structure —N═N-Q, wherein the —N═N— group is covalently bound to a carbon atom of the phenyl group and wherein Q is an aromatic group.

In the latter preferred embodiment the coating may include a second layer that includes a polymer or copolymer (i.e. (co)polymer) including at least one monomeric unit that includes at least one sulfonamide group. This layer is located between the layer described above including the oleophilic resin and the hydrophilic support. Hereinafter, ‘a (co)polymer including at least one monomeric unit that includes at least one sulfonamide group’ is also referred to as “a sulphonamide (co)polymer”. The sulphonamide (co)polymer is preferably alkali soluble. The sulphonamide group is preferably represented by —NR—SO₂—, —SO₂—NR— or —SO₂—NRR′ wherein R and R′ each independently represent hydrogen or an organic substituent.

Sulfonamide (co)polymers are preferably high molecular weight compounds prepared by homopolymerization of monomeric units containing at least one sulfonamide group or by copolymerization of such monomeric units and other polymerizable monomeric units.

Examples of monomeric units containing at least one sulfonamide group include monomeric units further containing at least one polymerizable unsaturated bond such as an acryloyl, allyl or vinyloxy group. Suitable examples are disclosed in U.S. Pat. No. 5,141,838, EP 1545878, EP 909,657, EP 0 894 622 and EP 1,120,246.

Examples of monomeric units copolymerized with the monomeric units containing at least one sulfonamide group include monomeric units as disclosed in EP 1,262,318, EP 1,275,498, EP 909,657, EP 1,120,246, EP 0 894 622 and EP 1,400,351.

Suitable examples of sulfonamide (co)polymers and/or their method of preparation are disclosed in EP-A 933 682, EP-A 982 123, EP-A 1 072 432, WO 99/63407 and EP 1,400,351. A highly preferred example of a sulfonamide (co)polymer (general formula (IV)) is disclosed in EP 1 604 818.

The layer including the sulphonamide (co)polymer may further include additional hydrophobic binders such as a phenolic resin (e.g. novolac, resoles or polyvinyl phenols), a chemically modified phenolic resin or a polymer containing a carboxyl group, a nitrile group or a maleimide group.

The dissolution behavior of the coating of the latter preferred embodiment in the developer can be fine-tuned by optional solubility regulating components. More particularly, development accelerators and development inhibitors can be used. In the preferred embodiment where the coating includes more than one layer, these ingredients can be added to the first layer, to the second layer and/or to an optional other layer of the coating.

Development accelerators are compounds which act as dissolution promoters because they are capable of increasing the dissolution rate of the coating. For example, cyclic acid anhydrides, phenols or organic acids can be used in order to improve the aqueous developability. Examples of the cyclic acid anhydride include phthalic anhydride, tetrahydrophthalic anhydride, hexahydrophthalic anhydride, 3,6-endoxy-4-tetrahydro-phthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″, 4″-tetrahydroxy-3,5,3′,5′-tetramethyltriphenyl-methane, and the like. Examples of the organic acids include sulphonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulphonic acid, dodecylbenzenesulphonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, 3,4,5-trimethoxybenzoic acid, 3,4,5-trimethoxycinnamic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole. Polymeric development accelerators such as phenolic-formaldehyde resins including at least 70 mol % meta-cresol as recurring monomeric units are also suitable development accelerators.

In a preferred embodiment, the coating also contains developer resistance means, also called development inhibitors, i.e. one or more ingredients which are capable of delaying the dissolution of the unexposed areas during processing. The dissolution inhibiting effect is preferably reversed by heating, so that the dissolution of the exposed areas is not substantially delayed and a large dissolution differential between exposed and unexposed areas can thereby be obtained. The compounds described in e.g. EP-A 823 327 and WO97/39894 are believed to act as dissolution inhibitors due to interaction, e.g. by hydrogen bridge formation, with the alkali-soluble resin(s) in the coating. Inhibitors of this type typically include at least one hydrogen bridge forming group such as nitrogen atoms, onium groups, carbonyl (—CO—), sulfinyl (—SO—) or sulfonyl (—SO₂—) groups and a large hydrophobic moiety such as one or more aromatic rings. Some of the compounds mentioned below, e.g. infrared dyes such as cyanines and contrast dyes such as quaternized triarylmethane dyes can also act as a dissolution inhibitor.

Other suitable inhibitors improve the developer resistance because they delay the penetration of the aqueous alkaline developer into the coating. Such compounds can be present in the first layer and/or, if present, in the second layer as described in e.g. EP-A 950 518, and/or in a development barrier layer on top of the layer, as described in e.g. EP-A 864 420, EP-A 950 517, WO 99/21725 and WO 01/45958. In the latter preferred embodiment, the solubility of the barrier layer in the developer or the penetrability of the barrier layer by the developer can be increased by exposure to heat or infrared light.

Preferred examples of inhibitors which delay the penetration of the aqueous alkaline developer into the coating include the following:
(a) A polymeric material which is insoluble in or impenetrable by the developer, e.g. a hydrophobic or water-repellent polymer or copolymer such as acrylic polymers, polystyrene, styrene-acrylic copolymers, polyesters, polyamides, polyureas, polyurethanes, nitrocellulosics and epoxy resins; or polymers including siloxane (silicones) and/or perfluoroalkyl units.
(b) Bifunctional compounds such as surfactants including a polar group and a hydrophobic group such as a long chain hydrocarbon group, a poly- or oligosiloxane and/or a perfluorinated hydrocarbon group. A typical example is Megafac F-177, a perfluorinated surfactant available from Dainippon Ink & Chemicals, Inc. A suitable amount of such compounds is between 10 and 100 mg/m², more preferably between 50 and 90 mg/m².
(c) Bifunctional block-copolymers including a polar block such as a poly- or oligo (alkylene oxide) and a hydrophobic block such as a long chain hydrocarbon group, a poly- or oligosiloxane and/or a perfluorinated hydrocarbon group. A suitable amount of such compounds is between 0.5 and 25 mg/m², preferably between 0.5 and 15 mg/m² and most preferably between 0.5 and 10 mg/m². A suitable copolymer includes about 15 to 25 siloxane units and 50 to 70 alkyleneoxide groups. Preferred examples include copolymers including phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. The poly- or oligosiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the polymer or oligomer is at least 2, preferably at least 10, more preferably at least 20. It may be less than 100, preferably less than 60.

It is believed that during coating and drying, the above mentioned inhibitor of type (b) and (c) tends to position itself, due to its bifunctional structure, at the interface between the coating and air and thereby forms a separate top layer even when applied as an ingredient of the coating solution of the first and/or of the optional second layer. Simultaneously, the surfactants also act as a spreading agent which improves the coating quality. The separate top layer thus formed seems to be capable of acting as the above mentioned barrier layer which delays the penetration of the developer into the coating.

Alternatively, the inhibitor of type (a) to (c) can be applied in a separate solution, coated on top of the first, optional second and/or other layers of the coating. In that preferred embodiment, it may be advantageous to use a solvent in the separate solution that is not capable of dissolving the ingredients present in the other layers so that a highly concentrated water-repellent or hydrophobic phase is obtained at the top of the coating which is capable of acting as the above mentioned development barrier layer.

In addition, the first or optional second layer and/or other layer may include polymers that further improve the run length and/or the chemical resistance of the plate. Examples thereof are polymers including imido (—CO—NR—CO—) pendant groups, wherein R is hydrogen, optionally substituted alkyl or optionally substituted aryl, such as the polymers described in EP-A 894 622, EP-A 901 902, EP-A 933 682 and WO 99/63407.

The coating of the heat-sensitive printing plate precursors described above preferably also contains an infrared light absorbing dye or pigment which, in the preferred embodiment where the coating includes more than one layer, may be present in the first layer, and/or in the second layer, and/or in an optional other layer. Preferred IR absorbing dyes are cyanine dyes, merocyanine dyes, indoaniline dyes, oxonol dyes, pyrilium dyes and squarilium dyes. Examples of suitable IR dyes are described in e.g. EP—As 823327, 978376, 1029667, 1053868, 1093934; WO 97/39894 and 00/29214. Preferred compounds are the following cyanine dyes:

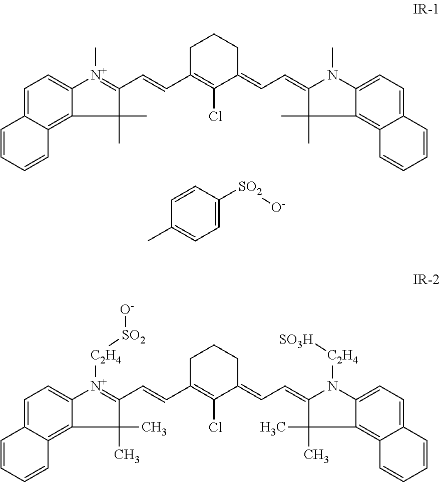

The concentration of the IR-dye in the coating is preferably between 0.25 and 15.0% wt, more preferably between 0.5 and 10.0% wt, most preferably between 1.0 and 7.5% wt relative to the coating as a whole.

The coating may further include one or more colorant(s) such as dyes or pigments which provide a visible color to the coating and which remain in the coating at unexposed areas so that a visible image is obtained after exposure and processing. Such dyes are often called contrast dyes or indicator dyes. Preferably, the dye has a blue color and an absorption maximum in the wavelength range between 600 nm and 750 nm. Although the dye absorbs visible light, it preferably does not sensitize the printing plate precursor, i.e. the coating does not become more soluble in the developer upon exposure to visible light. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in EP-A 400,706 are suitable contrast dyes. The contrast dye(s) may be present in the first layer, and/or in the optional second and/or other layers.

The heat-sensitive plate precursor can be image-wise exposed directly with heat, e.g. by means of a thermal head, or indirectly by infrared light, preferably near infrared light. The infrared light is preferably converted into heat by an IR light absorbing compound as discussed above. The heat-sensitive lithographic printing plate precursor is preferably not sensitive to visible light, i.e. no substantial effect on the dissolution rate of the coating in the developer is induced by exposure to visible light. Most preferably, the coating is not sensitive to ambient daylight.

The printing plate precursor can be exposed to infrared light by means of e.g. LEDs or a laser. Most preferably, the light used for the exposure is a laser emitting near infrared light having a wavelength in the range from about 750 to about 1500 nm, more preferably 750 to 1100 nm, such as a semiconductor laser diode, a Nd:YAG or a Nd:YLF laser. The required laser power depends on the sensitivity of the plate precursor, the pixel dwell time of the laser beam, which is determined by the spot diameter (typical value of modern plate-setters at 1/e² of maximum intensity: 5-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) platesetters. ITD plate-setters for thermal plates are typically characterized by a very high scan speed up to 500 m/sec and may require a laser power of several Watts. XTD plate-setters for thermal plates having a typical laser power from about 200 mW to about 1 W operate at a lower scan speed, e.g. from 0.1 to 10 m/sec. An XTD platesetter equipped with one or more laserdiodes emitting in the wavelength range between 750 and 850 nm is an especially preferred embodiment for the method of the present invention.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

After exposure, the precursor can be developed by means of a suitable processing liquid, such as an aqueous alkaline solution, whereby the non-image areas of the coating are removed; the development step may be combined with mechanical rubbing, e.g. by using a rotating brush. During development, any water-soluble protective layer present is also removed. The heat-sensitive printing plate precursors based on latex coalescence, can also be developed using plain water or aqueous solutions, e.g. a gumming solution. The gum solution is typically an aqueous liquid which includes one or more surface protective compounds that are capable of protecting the lithographic image of a printing plate against contamination or damaging. Suitable examples of such compounds are film-forming hydrophilic polymers or surfactants. The gum solution has preferably a pH from 4 to 10, more preferably from 5 to 8. Preferred gum solutions are described in EP 1,342,568. Alternatively, such printing plate precursors can after exposure directly be mounted on a printing press and be developed on-press by supplying ink and/or fountain to the precursor.

More details concerning the development step can be found in for example EP 1614538, EP 1614539, EP 1614540 and WO/2004071767.

### Light-Sensitive Printing Plate Precursors.

In addition to the above thermal materials, also light-sensitive coatings can be used in preferred methods of the present invention. Typical examples of such plates are the UV-sensitive “PS” plates and the so-called photopolymer plates which contain a photopolymerizable composition that hardens upon exposure to light.

In a particular preferred embodiment of the present invention, a conventional, UV-sensitive “PS” plate is used. Suitable examples of such plates, that are sensitive in the range of 300-450 nm (near UV and blue light), have been discussed in EP 1,029,668 A2. Positive and negative working compositions are typically used in “PS” plates.

The positive working imaging layer preferably includes an o-naphtoquinonediazide compound (NQD) and an alkali soluble resin. Particularly preferred are o-naphthoquinone-diazidosulphonic acid esters or o-naphthoquinone diazidocarboxylic acid esters of various hydroxyl compounds and o-naphthoquinone-diazidosulphonic acid amides or o-naphthoquinone-diazidocarboxylic acid amides of various aromatic amine compounds. Two variants of NQD systems can be used: one-component systems and two-component systems. Such light-sensitive printing plates have been widely disclosed in the prior art, for example in U.S. Pat. No. 3,635,709, J.P. KOKAI No. 55-76346, J.P. KOKAI No. Sho 50-117503, J.P. KOKAI No. Sho 50-113305, U.S. Pat. No. 3,859,099; U.S. Pat. No. 3,759,711; GB-A 739654, U.S. Pat. No. 4,266,001 and J.P. KOKAI No. 55-57841.

The negative working layer of a “PS” plate preferably includes a diazonium salt, a diazonium resin or an aryldiazosulfonate homo- or copolymer. Suitable examples of low-molecular weight diazonium salts include: benzidine tetrazoniumchloride, 3,3′-dimethylbenzidine tetrazoniumchloride, 3,3′-dimethoxybenzidine tetrazoniumchloride, 4,4′-diaminodiphenylamine tetrazoniumchloride, 3,3′-diethylbenzidine tetrazoniumsulfate, 4-aminodiphenylamine diazoniumsulfate, 4-aminodiphenylamine diazoniumchloride, 4-piperidino aniline diazoniumsulfate, 4-diethylamino aniline diazoniumsulfate and oligomeric condensation products of diazodiphenylamine and formaldehyde. Examples of diazo resins include condensation products of an aromatic diazonium salt as the light-sensitive substance. Such condensation products are described, for example, in DE-P-1 214 086. The light- or heat-sensitive layer preferably also contains a binder e.g. polyvinyl alcohol.

Upon exposure the diazo resins or diazonium salts are converted from water soluble to water insoluble (due to the destruction of the diazonium groups) and additionally the photolysis products of the diazo may increase the level of crosslinking of the polymeric binder or diazo resin, thereby selectively converting the coating, in an image pattern, from water soluble to water insoluble. The unexposed areas remain unchanged, i.e. water-soluble.

Such printing plate precursors can be developed using an aqueous alkaline solution as described above.

In a second suitable preferred embodiment, the light sensitive printing plate is based on a photo-polymerisation reaction and contains a coating including a photocurable composition including a free radical initiator (as disclosed in for example U.S. Pat. No. 5,955,238; U.S. Pat. No. 6,037,098; U.S. Pat. No. 5,629,354; U.S. Pat. No. 6,232,038; U.S. Pat. No. 6,218,076; U.S. Pat. No. 5,955,238; U.S. Pat. No. 6,037,098; U.S. Pat. No. 6,010,824; U.S. Pat. No. 5,629,354; DE 1,470,154; EP 024,629; EP 107,792; U.S. Pat. No. 4,410,621; EP 215,453; DE 3,211,312 and EP A 1,091,247) a polymerizable compound (as disclosed in EP1,161,4541; EP 1,349,006, WO 2005/109103, EP 1,788,448; EP 1,788,435; EP 1,788,443; EP 1,788,434) and a polymeric binder (as disclosed in for example US 2004/0260050, US 2005/0003285; US 2005/0123853; EP 1,369,232; EP 1,369,231; EP 1,341,040; US 2003/0124460, EP 1 241 002, EP 1,288,720; U.S. Pat. No. 6,027,857, U.S. Pat. No. 6,171,735; U.S. Pat. No. 6,420,089; EP 152,819; EP 1,043,627; U.S. Pat. No. 6,899,994; US 2004/0260050; US 2005/0003285; US 2005/0170286; US 2005/0123853; US 2004/0260050; US 2005/0003285; US 2004/0260050; US 2005/0003285; US 2005/0123853 and US 2005/0123853). Other ingredients such as sensitizers, co-initiators, adhesion promoting compounds, colorants, surfactants and/or printing out agents may optionally be added. These printing plates can be sensitized with blue, green or red light (i.e. wavelength range between 450 and 750 nm), with violet light (i.e. wavelength range between 350 and 450 nm) or with infrared light (i.e. wavelength range between 750 and 1500 nm) using for example an Ar laser (488 nm) or a FD-YAG laser (532 nm), semiconductor lasers InGaN (350 to 450 nm), an infrared laser diode (830 nm) or a Nd-YAG laser (1060 nm).

Typically, a photopolymer plate is processed in alkaline developer having a pH>10 (see above) and subsequently gummed. Alternatively, the exposed photopolymer plate can also be developed by applying a gum solution to the coating whereby the non-exposed areas are removed. Suitable gumming solutions are described in WO/2005/111727. After the exposure step, the imaged precursor can also be directly mounted on a press and processed on-press by applying ink and/or fountain solution. Methods for preparing such plates are disclosed in WO 93/05446, U.S. Pat. No. 6,027,857, U.S. Pat. No. 6,171,735, U.S. Pat. No. 6,420,089, U.S. Pat. No. 6,071,675, U.S. Pat. No. 6,245,481, U.S. Pat. No. 6,387,595, U.S. Pat. No. 6,482,571, U.S. Pat. No. 6,576,401, U.S. Pat. No. 6,548,222, WO 03/087939, US 2003/16577 and US 2004/13968.

To protect the surface of the coating of the heat and/or light sensitive printing plate precursors, in particular from mechanical damage, a protective layer may also optionally be applied. The protective layer generally includes at least one water-soluble binder, such as polyvinyl alcohol, polyvinylpyrrolidone, partially hydrolyzed polyvinyl acetates, gelatin, carbohydrates or hydroxyethylcellulose, and can be produced in any known manner such as from an aqueous solution or dispersion which may, if required, contain small amounts—i.e. less than 5% by weight based on the total weight of the coating solvents for the protective layer—of organic solvents. The thickness of the protective layer can suitably be any amount, advantageously up to 5.0 μm, preferably from 0.1 to 3.0 μm, particularly preferably from 0.15 to 1.0 μm.

Optionally, the coating may further contain additional ingredients such as surfactants, especially perfluoro surfactants, silicon or titanium dioxide particles or polymers particles such as matting agents and spacers.

Any coating method can be used for applying two or more coating solutions to the hydrophilic surface of the support. The multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimized. Drying is typically carried out by blowing hot air onto the coating, typically at a temperature of at least 70° C., suitably 80-150° C. and especially 90-140° C. Also infrared lamps can be used. The drying time may typically be 15-600 seconds.

Between coating and drying, or after the drying step, a heat treatment and subsequent cooling may provide additional benefits, as described in WO99/21715, EP-A 1074386, EP-A 1074889, WO00/29214, and WO/04030923, WO/04030924, WO/04030925.

The printing plates thus obtained can be used for conventional, so-called wet offset printing, in which ink and an aqueous dampening liquid are supplied to the plate. Another suitable printing method uses so-called single-fluid ink without a dampening liquid. Suitable single-fluid inks have been described in U.S. Pat. No. 4,045,232; U.S. Pat. No. 4,981,517 and U.S. Pat. No. 6,140,392. In a most preferred embodiment, the single-fluid ink includes an ink phase, also called the hydrophobic or oleophilic phase, and a polyol phase as described in WO 00/32705.

### EXAMPLES

### Example 1

### 1. Preparation and Characterization of the Aluminum Substrates AS-01 to AS-34

A 0.30 mm thick aluminum foil (1050 aluminum quality) was degreased by dipping it in an aqueous solution containing 34 g/l NaOH at 75° C. for 5 seconds (without moving the foil or stirring the solution) and rinsed for 5 seconds with demineralized water at room temperature (while continuously moving the foil). The foil was then electrochemically grained during 8 seconds using an alternating current with a density of 126 A/dm² in an aqueous solution containing 12 g/l HCl and 12 g/l SO₄²⁻ at a temperature of 37° C., resulting in a total charge density of 1000 C/dm². The pH of the graining electrolyte was 0.55. Before graining, the aluminum substrate was pre-etched for 3 seconds in the graining electrolyte.

### 2. Desmut Step

After the graining step the aluminum substrate was subjected to a desmut step involving a cathodic polarization in the graining electrolyte described above. The conditions of the cathodic polarization are described in Table 1. Subsequently, the foil was rinsed for 5 seconds with demineralized water at room temperature while continuously moving the aluminum substrate and dried.

### 3. Smut Evaluation

The aluminum substrates were respectively dipped in an aqueous solution containing 145 g/l H₂SO₄ at 80° C. for respectively 0 seconds, 3 seconds and 6 seconds. Subsequently the aluminum substrates were rinsed for 5 seconds in demineralised water at room temperature while continuously moving them and dried.

Subsequently, the L-values of the obtained aluminum substrates were measured using a GretagMacBeth SpectroEye spectrophotometer (commercially available from GretagMacBeth). There is a linear relation between the L-value of grained and desmutted aluminum substrates and the smut remaining on them, provided that the roughness value of the substrates are similar.

For each aluminum substrate the dip time at which the L-value becomes identical to the L-value of a reference aluminum substrate was established by linear interpolation.

The reference aluminum substrate is a substrate which was grained under identical conditions as the substrates AS-01 to AS-34 (as described above) and subsequently desmutted by dipping it in an aqueous solution containing 145 g/l H₂SO₄ at 80° C. for 6 seconds.

TABLE 1
Cathodic polarization conditions and smut results.

| | |
|---|---|
| Cathodic polarization | Time to |
| conditions | remove |

| Aluminum | Charge density | Current density | smut (1) |
|---|---|---|---|
| Substrate | C/dm² | A/dm² | s |
| AS-01, comp. | 25 | 80 | 3.05 |
| AS-02, comp. | 50 | 80 | 2.40 |
| AS-03, comp. | 100 | 80 | 1.91 |
| AS-04, comp. | 200 | 80 | 1.00 |
| AS-05, inv. | 500 | 80 | 0.00 |
| AS-06, comp. | 25 | 160 | 2.90 |
| AS-07, comp. | 50 | 160 | 2.64 |
| AS-08, comp. | 100 | 160 | 2.03 |
| AS-09, comp. | 200 | 160 | 0.70 |
| AS-10, inv. | 500 | 160 | 0.00 |
| AS-11, comp. | 25 | 240 | 2.60 |
| AS-12, comp. | 50 | 240 | 2.31 |
| AS-13, comp. | 200 | 240 | 0.67 |
| AS-14, inv. | 500 | 240 | 0.00 |
| AS-15, comp. | 50 | 80 | 2.23 |
| AS-16, comp. | 75 | 80 | 1.90 |
| AS-17, comp. | 100 | 80 | 1.95 |
| AS-18, comp. | 125 | 80 | 1.78 |
| AS-19, comp. | 50 | 180 | 2.48 |
| AS-20, comp. | 75 | 180 | 2.24 |
| AS-21, comp. | 100 | 180 | 2.01 |
| AS-22, comp. | 125 | 180 | 1.41 |
| AS-23, comp. | 50 | 200 | 2.15 |
| AS-24, comp. | 75 | 200 | 2.11 |
| AS-25, comp. | 100 | 200 | 1.75 |
| AS-26, comp. | 125 | 200 | 1.27 |
| AS-27, comp. | 50 | 220 | 2.43 |
| AS-28, comp. | 75 | 220 | 2.11 |
| AS-29, comp. | 100 | 220 | 1.94 |
| AS-30, comp. | 125 | 220 | 1.30 |
| AS-31, comp. | 50 | 240 | 2.38 |
| AS-32, comp. | 75 | 240 | 2.09 |
| AS-33, comp. | 100 | 240 | 1.84 |
| AS-34, comp. | 125 | 240 | 1.21 |

(1) dip time in 145 g/l H₂SO₄ @ 80° C. to get the same L-value as on the reference aluminum substrate.

From the results in Table 1 it is clear that at a charge density higher than 200 C/dm² during the cathodic polarization is required to remove the smut from the surface.

### Example 2

### 1. Preparation and Characterization of Aluminum Substrates AS-35 to AS-63

A 0.30 mm thick aluminum foil (1050 aluminum quality) was degreased by dipping it in an aqueous solution containing 34 g/l NaOH at 75° C. for 5 seconds (without moving the foil or stirring the solution) and rinsed for 5 seconds with demineralized water at room temperature (while continuously moving the foil). The foil was then electrochemically grained as indicated in Table 2 using an alternating current with a density of x A/dm² in an aqueous solution containing y′ g/l HCl and y″ g/l SO₄²⁻ at a temperature of 37° C., resulting in a total charge density of z C/dm². The pH of the graining electrolyte solutions used for AS-35 to AS-49 was 0.55 and the pH of the graining electrolyte solutions used for AS-50 to AS-63 was 0.25. Before graining the foil was pre-etched for 3 seconds in the graining electrolyte.

After the graining step the foil was subjected to a desmut step involving a cathodic polarization in the graining electrolyte described above under the conditions described in Table 2. Subsequently, the foil was rinsed for 5 seconds with demineralized water at room temperature while continuously moving the foil and dried.

In order to characterize the resulting aluminum substrates with regards to the presence of smut, different parts of the foil were dipped in an aqueous solution containing 145 g/l H₂SO₄ at 80° C. and this for respectively 0, 3 and 6 seconds. These parts were subsequently rinsed for 5 seconds in demineralised water at room temperature (while continuously moving them), dried and then subjected to a measurement of the L value using a GretagMacBeth SpectroEye spectrophotometer. By linear interpolation the dip time was established at which the L value becomes identical to this of a reference substrate foil, that had been grained under identical conditions as described above and subsequently desmutted by dipping it in an aqueous solution containing 145 g/l H₂SO₄ at 80° C. for 6 seconds.

TABLE 2
graining and cathodic polarization conditions and smut results.

| | | | | | Cathodic | | |
|---|---|---|---|---|---|---|---|
| | Graining conditions | | | | polarization | | |
| | HCl | Sulphate | Charge | Current | conditions | | |
| | Conc | Conc | density | density | Charge | Current | Time to |
| Aluminum | y′ | y″ | z | x | density | density | remove smut |
| Substrate | g/l | g/l | C/dm² | A/dm² | C/dm² | A/dm² | (1) s |
| AS-35, comp. | 12 | 12 | 1000 | 126 | 100 | 240 | 2.75 |
| AS-36 | 12 | 12 | 1000 | 126 | 200 | 240 | 2.56 |
| AS-37 | 12 | 12 | 1000 | 126 | 300 | 240 | 1.80 |
| AS-38, inv | 12 | 12 | 1000 | 126 | 400 | 240 | 0.1 |
| AS-39, inv | 12 | 12 | 1000 | 126 | 500 | 240 | 0.00 |
| AS-40 | 12 | 12 | 1000 | 76 | 100 | 240 | 3.40 |
| AS-41 | 12 | 12 | 1000 | 76 | 200 | 240 | 3.75 |
| AS-42 | 12 | 12 | 1000 | 76 | 300 | 240 | 2.34 |
| AS-43, inv | 12 | 12 | 1000 | 76 | 400 | 240 | 0.1 |
| AS-44, inv | 12 | 12 | 1000 | 76 | 500 | 240 | 0.00 |
| AS-45 | 12 | 12 | 1000 | 176 | 100 | 240 | 3.18 |
| AS-46 | 12 | 12 | 1000 | 176 | 200 | 240 | 2.93 |
| AS-47 | 12 | 12 | 1000 | 176 | 300 | 240 | 2.04 |
| AS-48, inv | 12 | 12 | 1000 | 176 | 400 | 240 | 0.00 |
| AS-49, inv | 12 | 12 | 1000 | 176 | 500 | 240 | 0.00 |
| AS-50 | 20 | 8 | 950 | 168 | 50 | 80 | 2.64 |
| AS-51 | 20 | 8 | 950 | 168 | 100 | 80 | 2.11 |
| AS-52 | 20 | 8 | 950 | 168 | 150 | 80 | 1.35 |
| AS-53 | 20 | 8 | 950 | 168 | 200 | 80 | 0.96 |
| AS-54 | 20 | 8 | 950 | 168 | 300 | 80 | 0.39 |
| AS-55, inv | 20 | 8 | 950 | 168 | 400 | 80 | 0.00 |
| AS-56, inv | 20 | 8 | 950 | 168 | 500 | 80 | 0.00 |
| AS-57 | 20 | 8 | 950 | 168 | 50 | 240 | 2.44 |
| AS-58 | 20 | 8 | 950 | 168 | 100 | 240 | 1.36 |
| AS-59 | 20 | 8 | 950 | 168 | 150 | 240 | 0.74 |
| AS-60 | 20 | 8 | 950 | 168 | 200 | 240 | 0.61 |
| AS-61 | 20 | 8 | 950 | 168 | 300 | 240 | 0.30 |
| AS-62, inv | 20 | 8 | 950 | 168 | 400 | 240 | 0.00 |
| AS-63, inv | 20 | 8 | 950 | 168 | 500 | 240 | 0.00 |

(1): dip time (s) in 145 g/l H₂SO₄ at 80° C. to get the same L-value as on the reference aluminum substrate.

From the results in Table 2 it is clear that at a charge density of at least 400 C/dm² is required during the cathodic polarization to remove the smut present on the surface.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A method for making a lithographic printing plate support comprising the steps of:
providing an aluminum support;
graining the aluminum support in a graining electrolyte solution; and
treating the grained aluminum support in a desmutting electrolyte solution containing hydrochloric acid by applying a direct current resulting in a charge density Q; wherein
the desmutting electrolyte solution has a pH less than 1 and the charge density Q is at least 400 C/dm².

12. The method according to claim 11, wherein the charge density Q ranges between 400 C/dm² and 1,000 C/dm².

13. The method according to claim 11, wherein the pH is greater than 0.

14. The method according to claim 11, wherein the charge density Q is obtained by applying the direct current for a time period ranging between 0.1 seconds and 10 seconds.

15. The method according to claim 11, wherein the charge density Q is obtained by applying the direct current for a time period of less than 5 seconds.

16. The method according to claim 11, wherein the direct current has a density ranging between 50 A/dm² and 300 A/dm².

17. The method according to claim 11, wherein the graining electrolyte solution and the desmutting electrolyte solution have the same composition.

18. The method according to claim 12, wherein the pH is greater than 0.

19. The method according to claim 13, wherein the charge density Q is obtained by applying the direct current for a time period ranging between 0.1 seconds and 10 seconds.

20. The method according to claim 13, wherein the charge density Q is obtained by applying the direct current for a time period of less than 5 seconds.

21. The method according to claim 15, wherein the charge density Q is obtained by applying the direct current for a time period of less than 5 seconds.

22. The method according to claim 15, wherein the direct current has a density ranging between 50 A/dm² and 300 A/dm².

23. The method according to claim 15, wherein the graining electrolyte solution and the desmutting electrolyte solution have the same composition.

24. The method according to claim 19, wherein the direct current has a density ranging between 50 A/dm² and 300 A/dm².

25. The method according to claim 19, wherein the graining electrolyte solution and the desmutting electrolyte solution have the same composition.

26. The method according to claim 17, wherein the graining step and the treating step are carried out in a same treatment tank or tanks.

27. The method according to claim 23, wherein the graining step and the treating step are carried out in a same treatment tank or tanks.

28. The method according to claim 26, wherein the treatment tank or tanks include one zone provided with AC power sources and another zone provided with DC power sources.

29. The method according to claim 27, wherein the treatment tank or tanks include one zone provided with AC power sources and another zone provided with DC power sources.

30. A method for making a lithographic printing plate precursor comprising the steps of:
providing the lithographic printing plate support obtained by the method of claim 11;
applying a coating including at least one heat-sensitive or light-sensitive imaging layer onto the lithographic printing plate support; and
drying the obtained precursor.
